(19) United States
(12) Patent Application Publication
(10) Pub. No.: US 2010/0330218 A1
(43) Pub. Date: Dec. 30, 2010

(54) SHAPING MOLD OF AIR FILTER

(75) Inventor: Mark HUNG, Lukang (TW)

Correspondence Address: RABIN & Berdo, PC, 1101 14TH STREET, NW, SUITE 500, WASHINGTON, DC, 20005, US

(73) Assignee: RED WOOD ENTERPRISE CO., LTD, Changhua Shien (TW)

(21) Appl. No.: 12/491,503

(22) Filed: Jun. 25, 2009

(51) Int. Cl. B29C 45/14

(52) U.S. Cl. 425/116

(57) ABSTRACT

A shaping mold of an air filter includes an upper mold base and a lower mold base, and a filter material having a corresponding shape is placed and fixed at a partition plate of the lower mold base to reduce manufacturing time and material cost of the mold, and also achieve the effects of providing a higher precision of positioning the filter material and improving the production efficiency, quality and reliability of the product.

### BACKGROUND OF THE INVENTION

1. Field of the Invention

The present invention relates to a shaping mold of an air filter, and more particularly to a shaping mold with an excellent manufacturing efficiency, simplified components, and a capability of forming an air filter by a one-time molding process.

2. Description of the Related Art

With reference to FIG. 1 for a conventional shaping mold 10 of an air filter, the shaping mold 10 is comprised of upper, middle and lower mold bases 11, 12, 13, wherein the upper and lower mold base 11, 13 includes a plurality of equidistant convex partition plates 111, 131 arranged alternately, and the middle mold base 12 forms a hollow mold hole 121 at the center of the middle mold base 12, such that when the upper mold base 11 is engaged with the lower mold base 13, the middle mold base 12 is clamped in the middle between the upper and lower mold bases 11, 13, such that the mold hole 121 is enclosed by the convex partition plates 111, 131 precisely.

When the shaping mold 10 is used for integrally forming an air filter 14, the middle mold 12 is engaged with the lower mold 13 first, and then a flat filter cotton plate 141 is placed at the top of the lower mold 13, and the upper mold 11 is pressed onto the middle and lower molds 12, 13 as shown in FIGS. 2 and 3. Now, the filter cotton plate 141 is pressed and squeezed by the alternate actions of the convex partition plates 111, 131 of the upper and lower mold bases 11, 13, such that the filter cotton plate 141 will be bent repeatedly in a form of having a predetermined interval apart equidistantly from one another, and then an injection device is provided for a rubber material from an injection runner 15 of the upper mold 11 and an injection hole 16 of the middle mold 12 into a mold hole 121 to form a plastic frame 142 wrapped around the external periphery of the filter cotton plate 141, and finally the upper, middle and lower molds 11, 12, 13 are separated into appropriate positions for removing the air filter and pressing the middle mold 12 downward to engage with the lower mold 13 so as to form the air filter 14 product.

However, the conventional shaping mold 10 can integrally form the air filter 14, yet the overall structural design involves a complicated inconvenient manufacturing process, and the actual manufactured products cannot meet the high quality requirements, and defects will be produced easily due to the following reasons:

1. The conventional shaping mold 10 requires the use of the upper, middle and lower molds 11, 12, 13, not just wasting manufacturing time and material cost of the molds, but also requiring a high precision for combining each mold in the manufacturing procedure, or else poor connecting positions will result and affect the external look of the product significantly.

2. The filter cotton plate 141 is formed directly by using the convex partitions 111, 131 of the upper and lower molds 11, 13 directly. Since the upper and lower molds 11, 13 are fixed onto the injection device already in the manufacturing procedure, and no accessory device is provided on the injection device for fixing and positioning the filter cotton plate 141, therefore the filter cotton plate 141 is simply placed on the lower mold 13. As a result, the filter cotton plate will be deviated or shifted easily when the upper and lower molds 11, 13 are engaged with each other, and an excessive deviation or shifting will cause the filter cotton plate 114 to retreat to a lateral edge 143 and fail to combine with the frame 142 to give rise to a defective product, or the whole filter cotton plate 141 may be tilted to affect the quality of the product significantly.

### SUMMARY OF THE INVENTION

In view of the shortcomings of the prior art, the inventor of the present invention based on years of experiment in the related industry to conduct extensive researches and experiments, and finally developed the shaping mold of an air filter in accordance with the present invention.

It is a primary objective of the present invention to provide a shaping mold of an air filter comprising an upper mold and a lower mold, and a filter material having a predetermined shape is placed and fixed at a partition plate of the lower mold base to reduce manufacturing time and material cost of the mold, and also achieve the effects of providing a higher precision of positioning the filter material and improving the production efficiency, quality and reliability of the product.

The objective of the invention, its structure, innovative features, and performance, will become apparent in the following detailed description of the preferred embodiments with reference to the accompanying drawings,

### BRIEF DESCRIPTION OF THE DRAWINGS

FIG. 1 is a partial exploded view of a conventional shaping mold of an air filter;

FIG. 2 is a schematic view of a closed conventional shaping mold of an air filter;

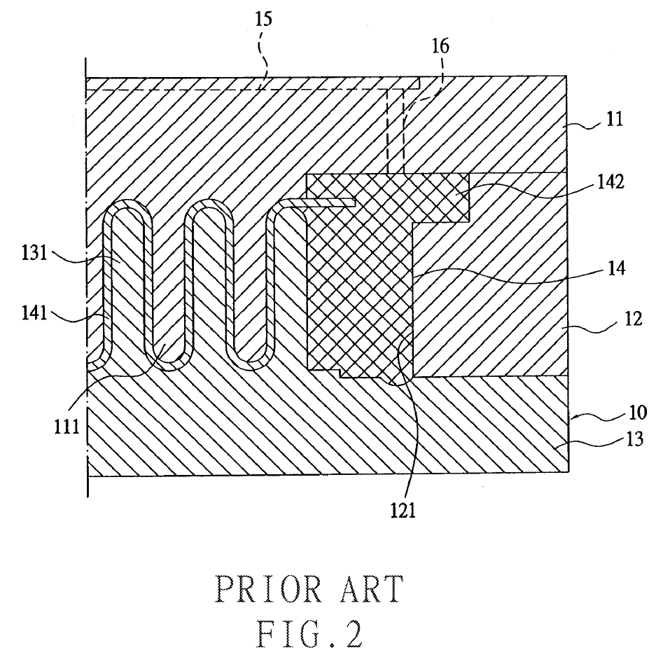

FIG. 3 is a schematic view of an opened conventional shaping mold of an air filter;

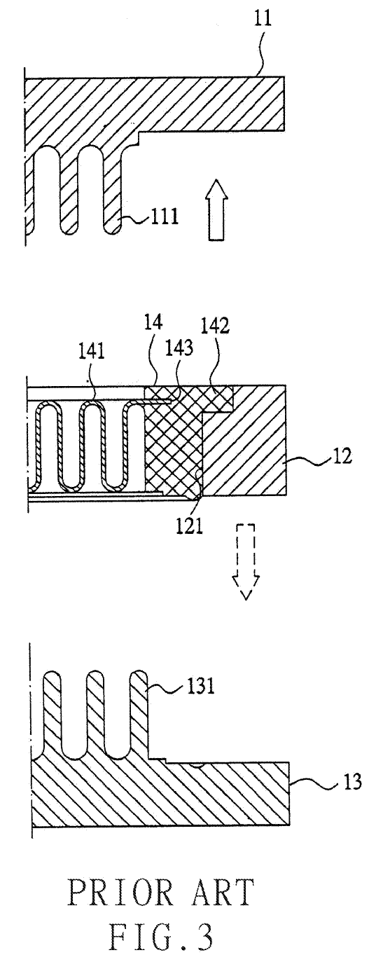

FIG. 4 is a perspective view of a shaping mold of an air filter in accordance with a preferred embodiment of the present invention;

FIG. 5 is a partial perspective view of an upper mold of a shaping mold in accordance with a preferred embodiment of the present invention;

FIG. 6 is a partial cross-sectional view of a shaping mold in accordance with a preferred embodiment of the present invention;

FIG. 7 is a schematic view of closing a shaping mold in accordance with a preferred embodiment of the present invention;

FIG. 8 is a schematic view of injecting a closed shaping mold in accordance with a preferred embodiment of the present invention;

FIG. 9 is a schematic view of opening a closed shaping mold in accordance with a preferred embodiment of the present invention;

FIG. 10 is a perspective view of an air filter product in accordance with a preferred embodiment of the present invention; and

FIG. 11 is a partial cross-sectional view of a shaping mold in accordance with another preferred embodiment of the present invention.

### DETAILED DESCRIPTION OF THE PREFERRED EMBODIMENTS

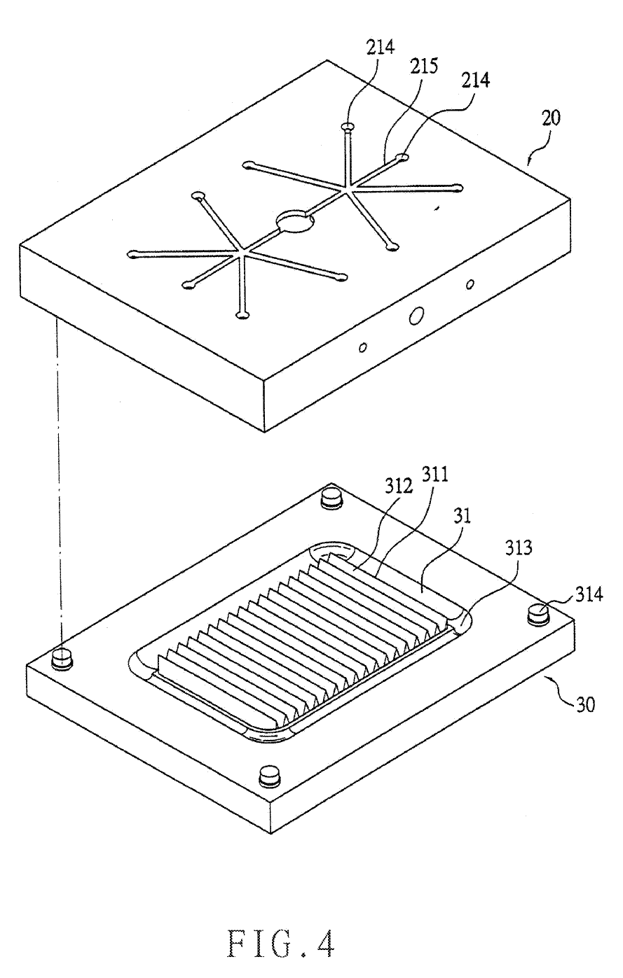

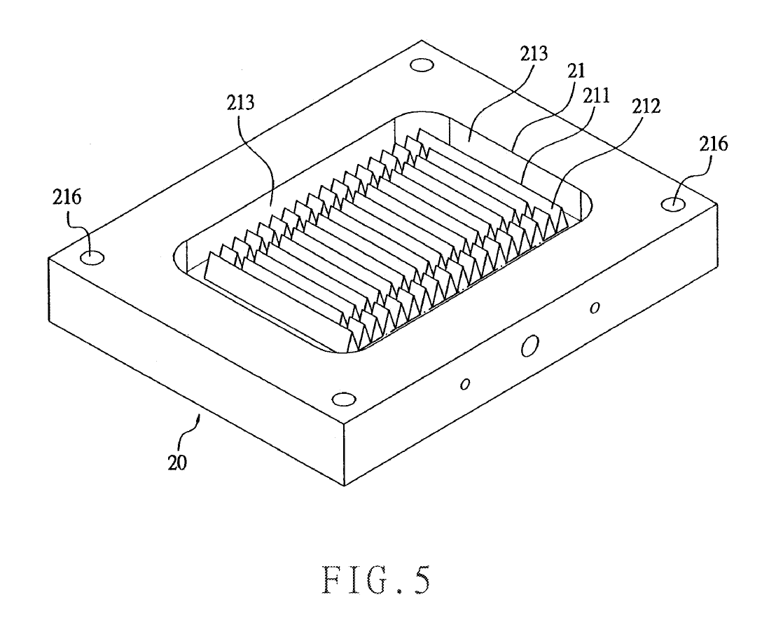

With reference to FIGS. 4 to 6 for a shaping mold of an air filter in accordance with a preferred embodiment of the present invention, the shaping mold comprises an upper mold 20 and a lower mold 30.

The upper mold 20 is substantially in a rectangular shape, and includes an upper cavity 21 concavely disposed at the bottom of the upper mold 20 and having a predetermined depth, a plurality of equidistant partitions 211 extended downwardly from the bottom of the upper cavity 21, and an upper containing space formed between two partitions 211, wherein the partitions 211 are arranged in a triangular shape, and a containing groove 212 formed therein is also a triangular groove, and the periphery of the upper cavity 21 is not connected, so as to form a circular groove 213 with a predetermined distance apart, and a plurality of injection holes 213 are formed at predetermined positions of the circular groove 213 and interconnected with the top of the upper mold 21, and the top of the upper mold 21 includes a plurality of injection runners 215 interconnected with one another and communicated with the injection holes 214 for guiding and injecting the raw plastic material from the injection holes 214 into the circular groove 213, wherein some injection holes 214 are near the four sides of the circular groove 213, and a connecting hole 216 is disposed on the four sides of the bottom side of the upper mold 21 and disposed a slightly inner position separately.

The lower mold 30 is engaged to the bottom of the upper mold 20, and includes a lower cavity 31 disposed at the top of the lower mold 30, a plurality of equidistant lower partitions 311 protruded upwardly from the bottom of the lower cavity 31 and arranged into a triangular shape, a lower containing groove 312 formed among the partitions 311, such that when the upper and lower molds 20, 30 are engaged, the partitions 211, 311 are installed alternately and respectively into the containing grooves 312, 212. In addition, the partitions 311 are not connected with the periphery of the lower cavity 30 to form a circular groove 313 with a predetermined interval apart and corresponding to the circular groove 213 of the upper cavity 21, an the circular groove 313 is formed into an arc groove. In addition, a connecting rod 314 is disposed at a slightly inner position of four sides of the top of the lower mold 30 and inserted into the respective connecting hole 216.

The structure, position and interconnection of each component of the present invention are disclosed as above, and the shaping process and the expected effects of the present invention will be described as follows:

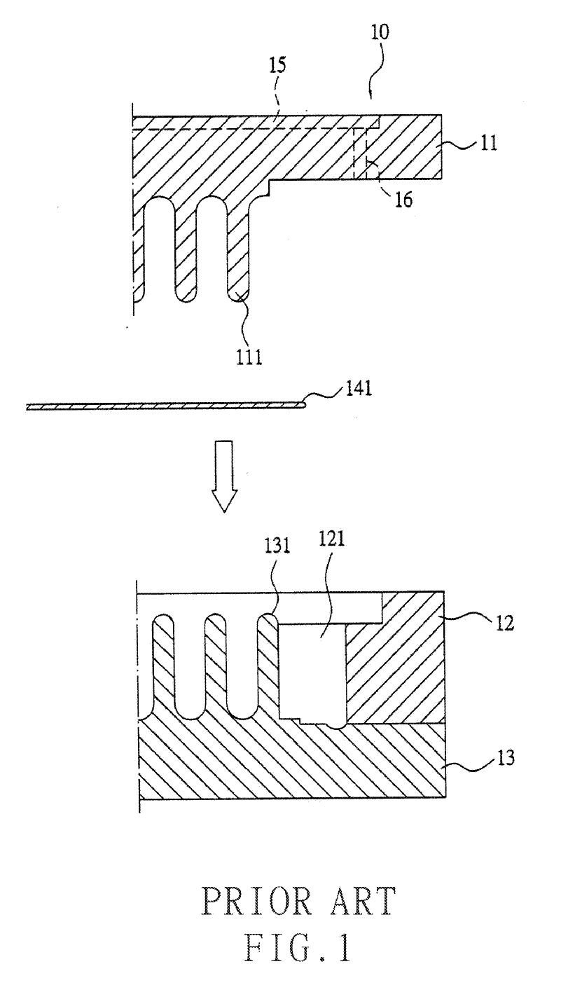

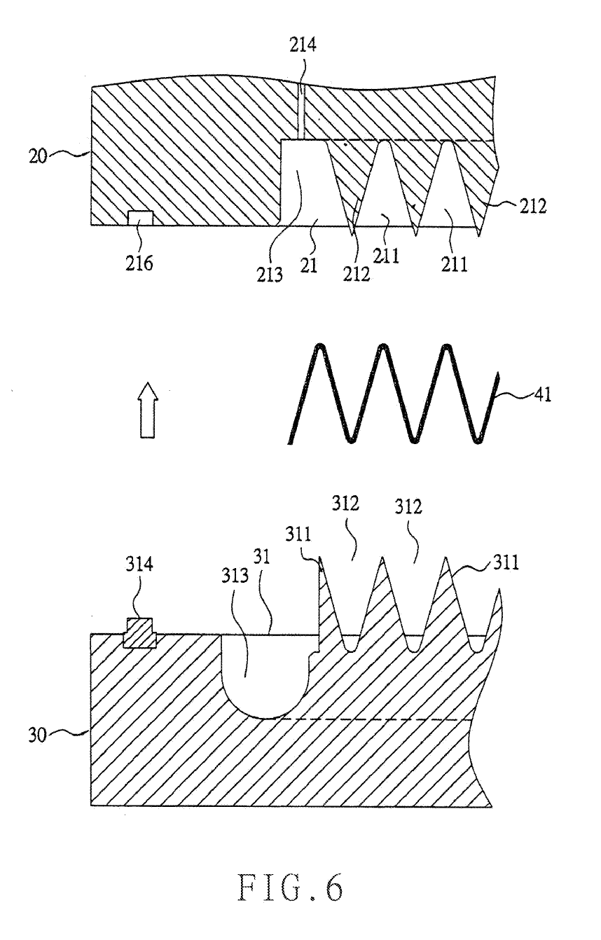

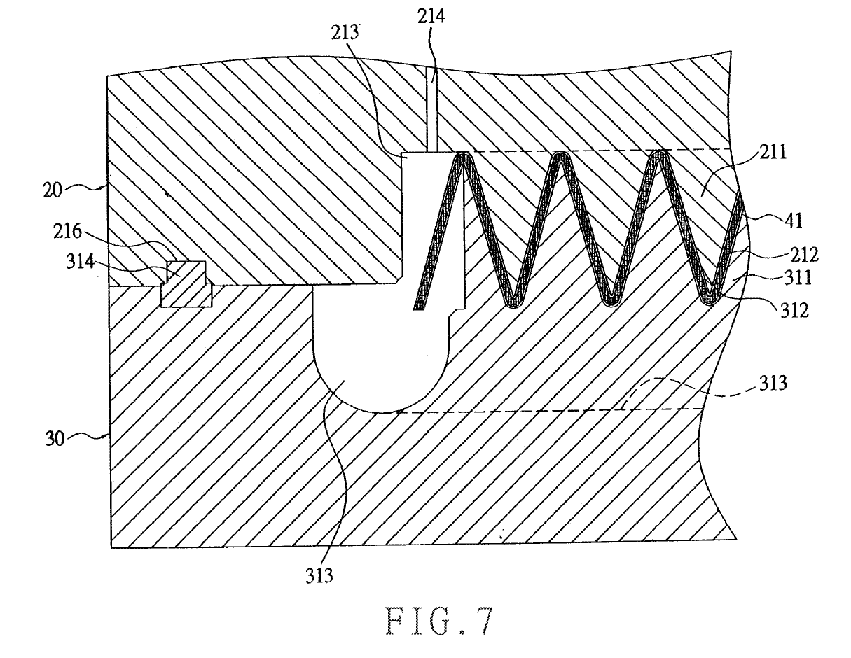

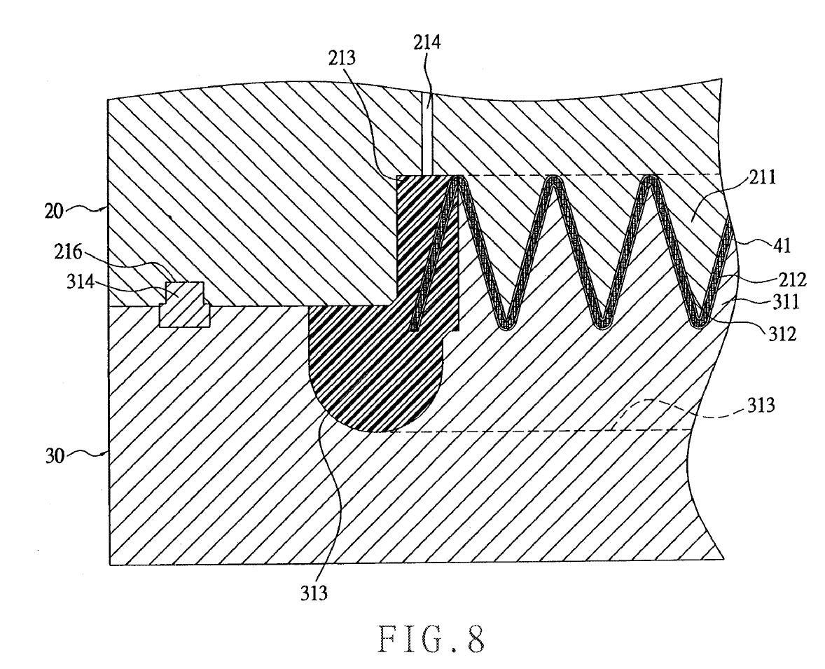

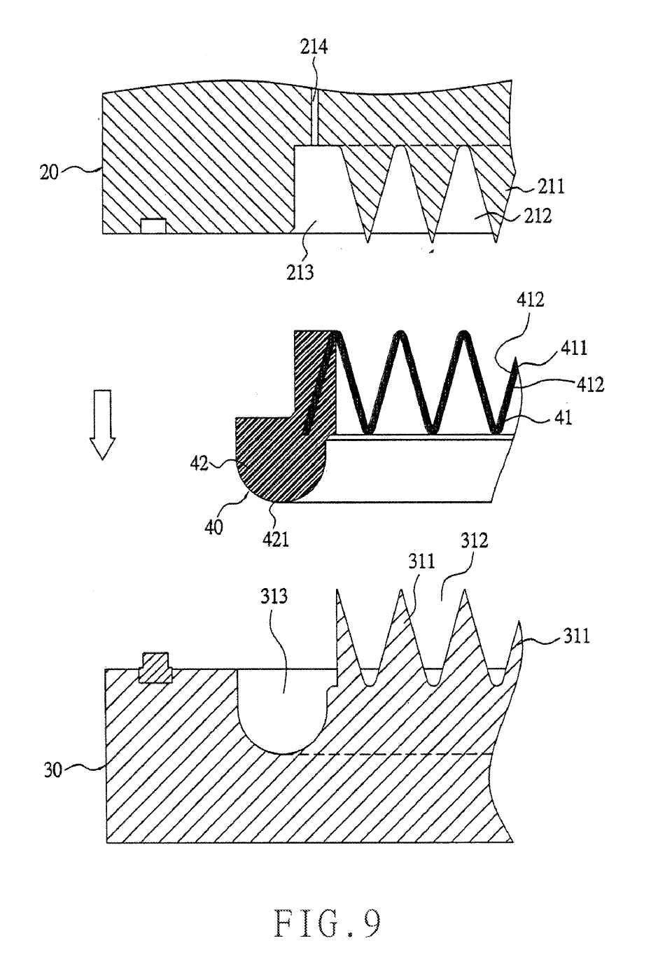

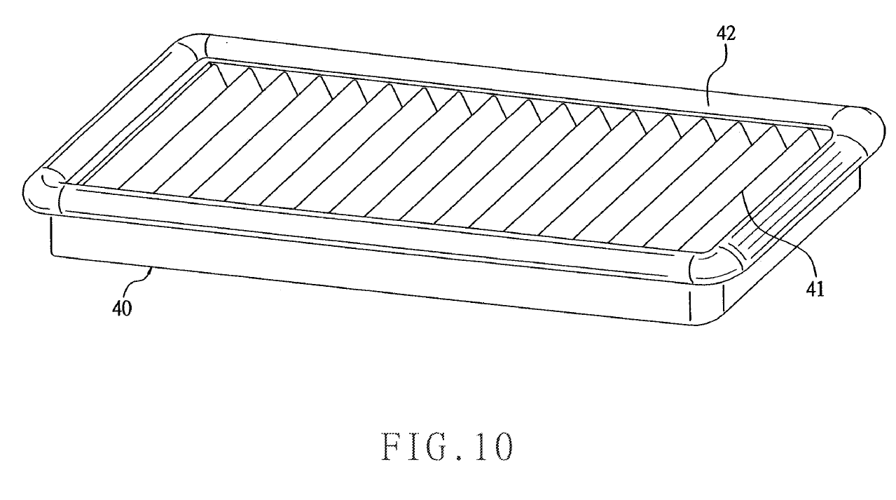

Firstly, when the air filter 40 of the invention is molded as shown in FIGS. 6 and 7, the shaping mold is preinstalled onto an injection device, such that when the manufacture takes place, a filter material 41 pre-shaped with repeated concave bent shape is placed onto the partition 311 of the lower cavity 31, and then the upper and lower molds 20, 30 are engaged with each other into a closed state. Now, the partitions 211 in the upper cavity 21 and the partitions 311 in the lower cavity 31 are clamped and pressed alternately onto the filter material 40. With reference to FIGS. 1 and 8, the injection device is provided for injecting a rubber injection material from the injection runners 215 and the injection holes 214 into the circular grooves 213, 313 of the upper and lower cavities 21, 31, and a frame 42 is formed by wrapping and combining a portion of the filter material 41 around the external periphery of the air filter 40. With reference to FIGS. 9 and 10, until the aforementioned injection is completed, the upper and lower molds 20, 30 are separated into an open mold state, and the air filter 40 product is removed such that the integrally formed structure has an excellent structural strength, and a stable quality.

In FIG. 9, the filter material 41 of the preferred embodiment is comprised of a filter fabric 411 or a metal mesh layer 412, wherein the filter fabric 411 is a piece of unwoven cloth or cotton cloth, and the metal mesh layer 412 is wrapped around the surface of the filter fabric 411 for enhancing the structural strength. In addition, the filter material 41 can be metal mesh layer made of stainless steel or filter fabric according to the customer requirements to provide different levels of the filtering effect. The circular groove 313 of the lower cavity 31 of the lower mold 30 is a circular arc groove, such that after the frame 42 of the air filter 40 is formed, a guide surface 421 with a predetermined curvature is formed at the top edge of the frame 42. When the air filter 40 is used, the smooth circumference of the guide surface 421 is provided for guiding the air through the filter material 41 to achieve the effects of filtering and reducing the chance of producing reflecting airflow, and enhancing the intake of airflow of a high efficiency engine.

In FIGS. 1 and 7, some of the injection holes 214 of the upper mold 20 are designed next to the four sides of the circular groove 213, such that when the injection material can be injected and filled into everywhere inside the circular grooves 213. 313 quickly, and the sides of the filter material are wrapped and fixed by the filled injection material, so as to prevent deformation or warping occurred at any sides of the filter material 41 when overheated, and achieve an excellent shaping quality.

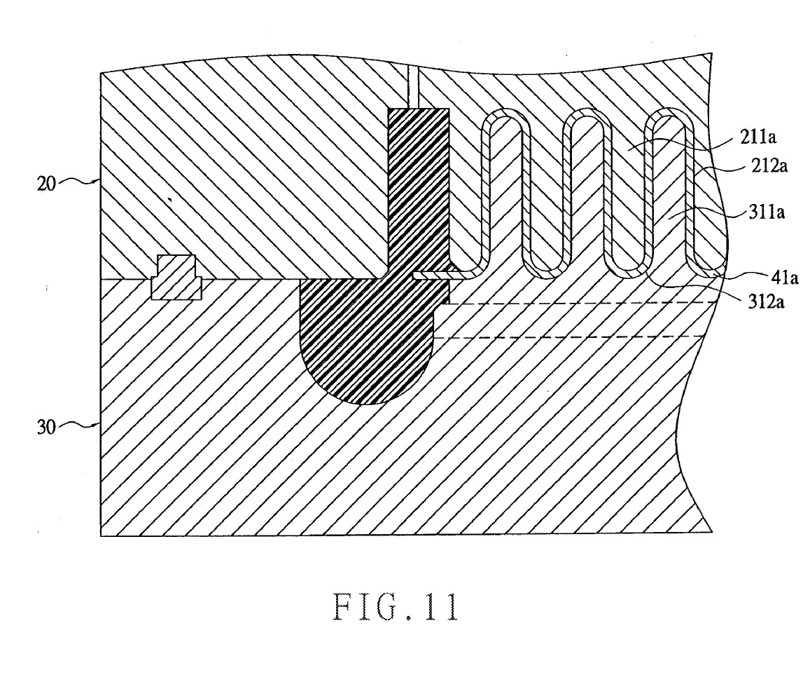

With reference to FIG. 11 for a shaping mold comprised of an upper mold 20 and a lower mold 30 in accordance with another preferred embodiment of the present invention, the partitions 211a, 311a are made into corresponding cylindrical shape with a circular arc surface at distal ends, and the containing grooves 212a, 312a are also cylindrical grooves, and the filter material 411a is also in a corresponding cylindrical shape with continuous concave bends, such that the overall manufacturing efficiency and the product quality can be enhanced regardless of different shapes of the product.

It is noteworthy to point out that the shaping mold of an air filter in accordance with the present invention simply adopts an upper mold and a lower mold to achieve the effect of molding the air filter in a one-time molding process, and the overall structure of the invention is simpler than the conventional shaping mold, not only saving the cost for the molds, but also providing a quick and convenient mold closing and opening procedure for manufacturing the air filter since the shaping mold is composed of the upper and lower molds, so as to enhance the production efficiency effectively. In addition, the filter material is manufactured into a shape with continuous concave bends in the upper and lower cavities in advance, and thus the filter material can be positioned quickly during the manufacturing process without the risk of having a deviation or shifting easily, and the filter material and the frame can be combined with one another precisely. Overall speaking, the quality of the product can be improved.

In summation of the above description, the present invention herein enhances the performance than the conventional structure and further complies with the patent application requirements and is submitted to the Patent and Trademark Office for review and granting of the commensurate patent rights.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A shaping mold of an air filter, comprising:
an upper mold, including an upper cavity with a predetermined depth and disposed concavely on the upper mold, a plurality of equidistant partitions protruded downwardly from the bottom of the upper cavity, a containing groove formed between adjacent partitions, and the partitions not being connected to the periphery of the upper cavity to form a circular groove with a predetermined distance apart, a plurality of injection holes formed at predetermined position of the circular groove and interconnected with the top of the upper mold, a plurality of interconnected injection runners disposed at the top of the upper mold and interconnected with the injection holes for guiding and filling an injection material from the injection holes into the circular groove, and a connecting hole disposed separately at a slightly inner position of four sides of the bottom of the upper mold;
a lower mold, engaged with the bottom of the upper mold, and including a lower cavity disposed at the top of the lower mold, a plurality of equidistant partitions protruded upwardly from the bottom of the lower cavity, a containing groove formed between adjacent partitions, such that when the upper and lower molds are engaged, the partitions are installed alternately and respectively into the containing groove, a circular groove formed with a predetermined interval, and not connected with the partitions and the periphery of the lower cavity and corresponding to the circular groove of the upper cavity, and a connecting rod installed at a slightly inner position of four sides of the top of the lower mold and inserted into the respective connecting hole;
thereby, a filter material of a predetermined form with continuous bends is placed on the partition of the lower cavity, and after the upper and lower cavities are engaged and fixed, the injection material is injected into the injection runners, the injection material is filled into the circular grooves of the upper and lower cavities sequentially to wrap and combine a portion of the periphery of the filter material to form a frame at an external side of the air filter, so as to provide an air filter with an excellent structural strength and a high manufacturing efficiency.

2. The shaping mold of an air filter as recited in claim 1, wherein the partitions of the upper and lower cavities are arranged into a triangular shape with a triangular groove enclosed among the containing grooves.

3. The shaping mold of an air filter as recited in claim 1, wherein the injection material is a rubber material.

4. The shaping mold of an air filter as recited in claim 1, wherein the filter material is composed of a filter fabric and a metal mesh layer, and the filter fabric is a piece of filter cloth or cotton cloth with a filtering effect, and the metal mesh layer is wrapped and covered onto a surface of the filter fabric for providing a better structural strength.

5. The shaping mold of an air filter as recited in claim 1, wherein the shaping mold of an air filter as recited in claim 1, wherein the filter material is a metal mesh layer made of stainless steel for enhancing the structural strength of the filter material and facilitating cleaning and reusing the filter material.

6. The shaping mold of an air filter as recited in claim 1, wherein the partitions of the upper and lower cavities are formed in a cylindrical shape with a circular arc surface at distal ends, and a corresponding cylindrical containing groove is formed among the partitions.

7. The shaping mold of an air filter as recited in claim 1, wherein the lower cavity includes a circular arc surface formed at an upper edge of the circular groove of the lower cavity, such that after the frame of the air filter is formed, a guide surface with a predetermined curvature is formed at the top edge of the frame.

8. The shaping mold of an air filter as recited in claim 1, wherein the upper mold includes an injection hole disposed at a position proximate to four sides of the circular groove, such that when the shaping mold is manufactured, the injection material can be injected and filled into the position of the injection hole quickly.
